(19) United States
(12) Patent Application Publication
(10) Pub. No.: US 2005/0128754 A1
(43) Pub. Date: Jun. 16, 2005

(54) Ceramic foam light diffuser

(76) Inventor: Myron K. Redden, Hendersonville, NC (US)

Correspondence Address: NEXSEN PRUETT JACOBS & POLLARD, 201 W MCBEE AVENUE, SUITE 400, GREENVILLE, SC, 29601, US

(21) Appl. No.: 11/007,105

(22) Filed: Dec. 8, 2004

Related U.S. Application Data
(60) Provisional application No. 60/529,395, filed on Dec. 12, 2003.

(51) Int. Cl. F21V 5/00

(52) U.S. Cl. 362/311; 362/352; 362/246

(57) ABSTRACT

A lamp with an illuminator and a porous ceramic diffuser

### CROSS-REFERENCE TO RELATED APPLICATIONS

The present invention claims priority to U.S. Provisional Patent Application No. 60/529,395 filed Dec. 12, 2003 which is pending.

### BACKGROUND OF THE INVENTION

The present invention is directed to improved lighting assemblies and particularly to light diffusers used with lighting assemblies.

Decorative lighting is widely used in domestic and commercial settings for function and aesthetics purposes.

Virtually all lighting applications involve a source of illumination and a diffuser. The illuminator provides the illumination and many types are available. The diffuser, also referred to as a shade, serves several functions. The primary function of the diffuser is to diffuse the light to avoid the appearance of a point source of light. This allows larger areas to be illuminated while decreasing the glare typically associated with an uncovered light bulb or illuminator.

Another function of the diffuser is aesthetics. Diffusers come in a large variety of shapes, sizes and colors as well a variety of materials. One limitation of diffusers is the propensity for degradation when subjected to heat from the illuminator. This has limited the use and design of diffusers in many applications.

Formation of a light diffuser is dependent on the material used for construction. Each type of material has advantages and limits. Plastic diffusers, for example, are typically vacuum formed, or molded, which prohibits the use of negative angles in the design. Cloth, or cellulose, based diffusers are limited to the underlying support structure shape and their propensity to degrade in heat limits the designs in which they can be incorporated. Glass diffusers, which may be etched, are limited by their poor structural integrity.

There has been a long felt desire for light diffusers which are easy to manufacture, aesthetically pleasing, not limited in shape or form and which do not demonstrate thermal degradation.

### SUMMARY OF THE INVENTION

It is an object of the present invention to provide a light diffuser, and light assembly comprising a diffuser, which is not susceptible to thermal degradation.

It is another object of the present invention to provide a light diffuser, and light assembly comprising a diffuser, which is easily manufactured in virtually any configuration or shape.

It is yet another object of the present invention to provide a light diffuser, and light assembly comprising a diffuser, which is aesthetically pleasing.

These and other advantages, as will be realized, are provided in a lamp with an illuminator and a porous ceramic diffuser.

Yet another embodiment is provided in a light with a base with a porous ceramic diffuser attached to the base. The porous ceramic diffuser has a cavity and an illuminator is attached to said base and in said cavity.

Yet another embodiment is provided in a light comprising a porous ceramic diffuser assembly with at least one porous ceramic diffuser with an average pore size of at least 15 μm to no more than 7000 μm and a cavity and an illuminator in the cavity.

### BRIEF DESCRIPTION OF THE DRAWINGS

FIG. 1 is a side view of an embodiment of the present invention.

FIG. 2 is a top view of the embodiment of FIG. 1.

FIG. 3 is a front view of an embodiment of the present invention.

FIG. 4 is a cross-sectional view taken along line 4-4 of FIG. 3.

FIG. 5 is a front view of an embodiment of the present invention.

FIG. 6 is a cross-sectional view of the embodiment of FIG. 5 taken along line 6-6.

FIG. 7 is a partial cross-sectional view of an embodiment of the present invention.

### DETAILED DESCRIPTION OF THE DRAWINGS

The present invention will be described with particular emphasis on the figures without limit thereto. In the various figures, similar elements will be numbered accordingly.

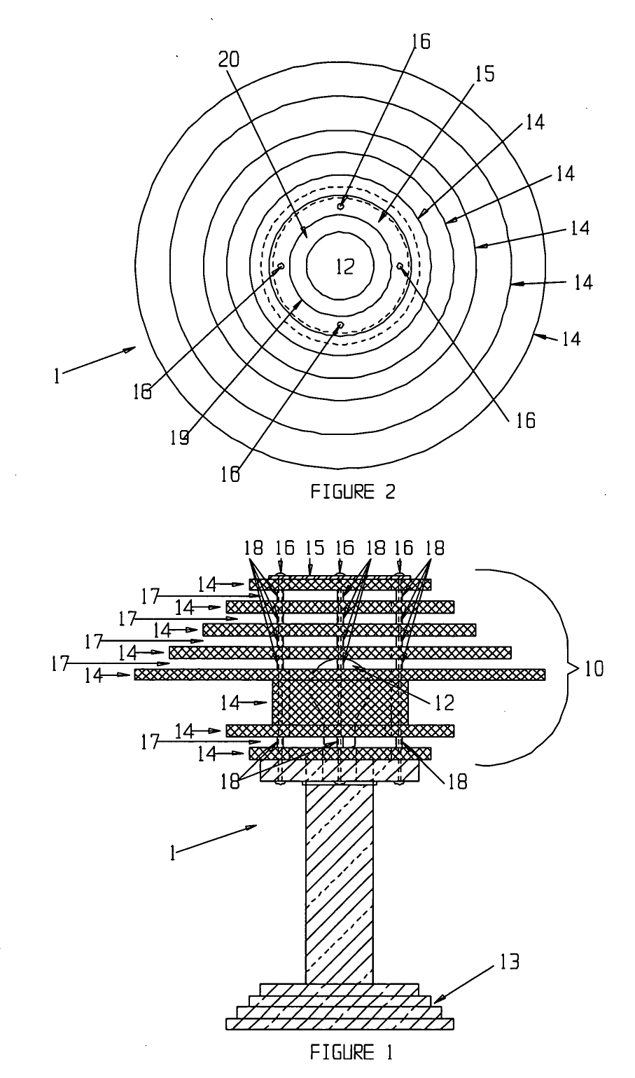

An embodiment of the present invention is illustrated in side view in FIG. 1 and in top view in FIG. 2. In FIGS. 1 and 2, a lamp, generally represented by 1, comprises a ceramic light diffuser assembly, 10, of the present invention. The ceramic light diffuser assembly, 10, comprises a multiplicity of substantially planar ceramic light diffusers, 14, with each substantially planar ceramic light diffuser being either abutted to, or separated with a space between, each adjacent substantially planar section. Each diffuser contains a central void which, when taken together, form a cavity, 20, within which the illuminator, 12, resides. It is preferable that a heat vent be incorporated into the ceramic light diffuser assembly either by spacings, 17, between adjacent ceramic light diffusers, 14, or with a vent void, 19.

The ceramic light diffuser assembly, 10, is preferably secured by an attachment element, 16, such as matching threaded elements, rivets, and the like to a base, 11. The base, 11, may comprise a foot, 13, to provide a larger stabilizing area upon which the lamp rest. Sleeves, 18, or a suitable separator forms separations between adjacent diffusers.

An illuminator, 12, is preferably interior to the ceramic light diffuser assembly, 10, and within the cavity, 20, formed by the central voids of the diffusers. The illuminator causes the ceramic light diffusers, 14, to appear as if they are internally illuminated. It would be apparent that the combination of spaces, 17, and abutted ceramic diffusers provides an aesthetic and functional appeal which can be easily utilized by one of skill in the art to achieve the desired effect. A cap, 15, or washers, as known in the art may be incorporated if desired.

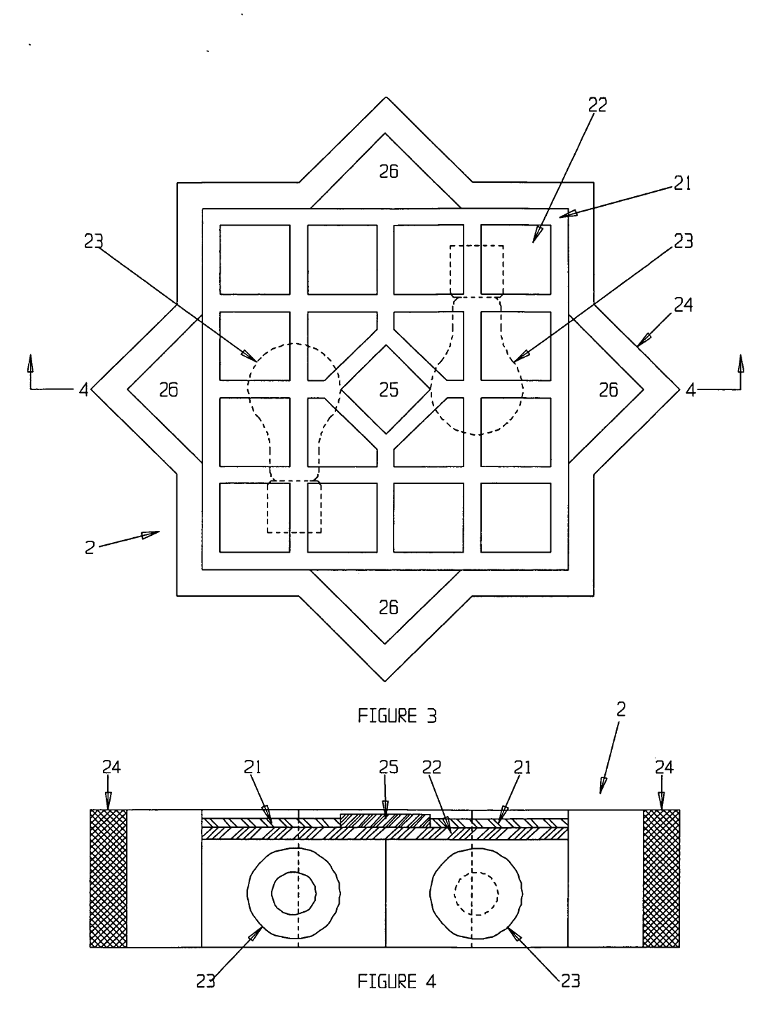

Another embodiment of the present invention is illustrated in front view in FIG. 3 and in cross-sectional view in FIG. 4 taken along line 4-4 of FIG. 3. The embodiment of FIGS. 3 and 4 is referred to as a flush-mount due to the ability to mount the lamp, generally represented at 2, on a surface such as a wall. The flush-mount embodiment comprises a first optionally patterned ceramic diffuser, 21, illustrated as a grid, and a second optionally patterned ceramic diffuser, 22, in layered relationship. The optionally patterned diffusers provide for different amounts of light to traverse the ceramic diffuser at different locations on the face of the lamp. For example, the outer ceramic diffuser, 21, can have a pattern such as a grid, as shown, and the inner ceramic diffuser, 22, can be non-patterned. In this arrangement some light traverses only the inner ceramic diffuser and some light traverses both the inner and outer ceramic diffuser. As would be apparent to one of skill in the art the areas represented by a single ceramic diffuser would appear brighter than those areas represented by overlapping ceramic diffusers. Any area of the ceramic assembly may comprise a third ceramic diffuser, 25, which provides an area with a third level of illumination. The ceramic assembly, represented by elements 21, 22 and 25 in the embodiment illustrated in FIGS. 3 and 4 is preferably contained within a frame, 24. Additional accent sections, 26, which may be opaque, transparent or a ceramic diffuser, can be provided for additional aesthetic appeal or function. The embodiment illustrated in FIGS. 3 and 4 comprises multiple illuminators, 23. While illustrated herein with two layers of diffuser one or multiple layers can be incorporated depending on the aesthetic and functional necessities.

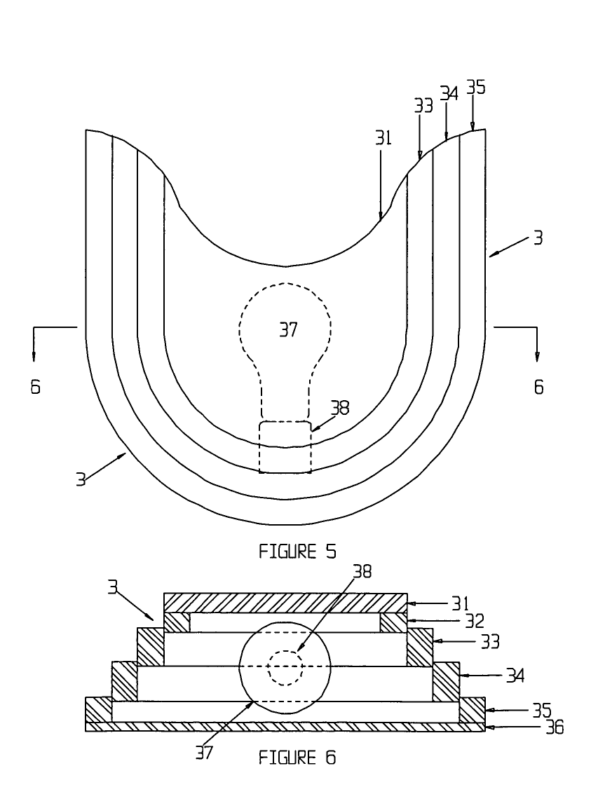

Yet another embodiment of the present invention is illustrated in front view in FIG. 5 and cross-sectional view in FIG. 6 taken along line 6-6 of FIG. 5. The embodiment illustrated in FIGS. 5 and 6, generally represented at 3, represents a light structure typically referred to as a sconce which is typically mounted on a surface. The exterior shape, while illustrated herein as a “U” shape is not particularly limited.

The embodiment illustrated in FIGS. 5 and 6, comprises an optional base plate, 36, which provides a mounting surface and may insulate the underlying surface from heat generated by the illuminator, 37, in a fixture, 38. Attached to the base plate, 36, are a series of ceramic diffusers, 32-35, forming a center cavity within which the illuminator, 37, is contained. A cap, 31, which may be a ceramic diffuser, an opaque material, an etched glass or a transparent material, provides additional aesthetic and functional properties as would be realized by one of skill in the art. Each successive layer of ceramic diffuser may be progressively smaller as illustrated. Alternatively, each successive layer may be the same size, or larger than the adjacent ceramic diffuser. In another embodiment one, or more, of the successive layers may be transparent or opaque to provide a mixture of light transmission properties.

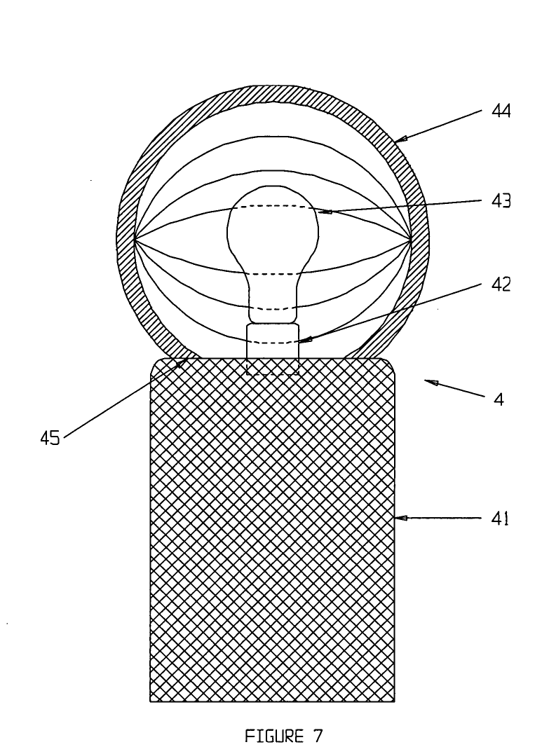

Another embodiment is illustrated in cross-sectional view in FIG. 7. In FIG. 7, the lamp, generally represented at 4, comprises a base, 41. Attached to the base is a porous ceramic diffuser, 44, with a central cavity, 45. Within the cavity, 45 is a fixture, 42, with an illuminator, 43, attached thereto. The fixture, 42, is attached to the base, 41. In the embodiment of FIG. 7, the porous ceramic diffuser, 44, is a hollow structure also referred to as a globe. The hollow structure is illustrated as spherical yet other shapes and configurations could be utilized without departing from the scope of the invention. An access void, 45, allows the globe to be removed to change the illuminator.

It would be readily within the skill of those in the art to configure an illuminator and power source and further discussion directed thereto is not necessary. The illuminator may be incandescent, fluorescent, diode, laser, combustion, phosphorescent, or other known device capable of generating visible light of singular or multiple wavelengths.

The porosity of the diffuser is selected based on the amount of light desired to be passed to the outer extent of the diffuser. High porosity, or more pores per length of surface, blocks more light and therefore provides a darker appearance at a given thickness. Higher porosities are preferred when the lamp is to act as accent lighting without a desire to illuminate an area. Lower porosity, or fewer pores per length of surface, indicates a more open structure which allows more light through the diffuser at a given thickness therefore providing a brighter appearance. Lower porosity is more preferred when the lamp is intended to illuminate an area. The porosity is selected based on the aesthetic appeal and function sought and the thickness of the diffuser. As the thickness increases the porosity must be lower to allow adequate light through the diffuser. In general, for a 12.7 mm thick diffuser the average pore size should be no more than about 7000 μm, or about 3.6 pores per inch to no less than an average pore size of about 15 μm or about 1695 pores per inch. Below an average pore size of about 15 μm the amount of light transmission is insufficient to light the exterior of the diffuser. Above an average pore size of about 7000 μm the diffuser becomes brittle and the illuminator becomes visible which is undesirable for aesthetic purposes. More preferably, the diffuser has an average pore size of about 500 μm to about 7000 μm.

The process for manufacturing the diffuser involves the technique referred to in the art as sponge replication. This technique involves forming an open cell foam in the shape of the intended diffuser. The open cell foam is then saturated with a ceramic precursor solution such that the pores of the open cell foam are adequately filled with ceramic precursor. The entire assembly is then dried to form a green ceramic precursor followed by heating at elevated temperature to remove the foam, solvents, and all organic matter and to sinter the ceramic precursors. As would be realized the ceramic structure corresponds with those areas which were voids in the open cell foam and the voids in the ceramic correspond to those areas which were structure in the open cell foam.

The open cell foam preferably has a plurality of interconnected voids surrounded by a web of flexible foam material.

The open cell foam can be made of any material which can be impregnated with ceramic precursor and which can be removed by heating. Generally, any combustible organic plastic foam may be used which has resilience and the ability to recover to original shape. Preferred open cell foams are typically polymeric organic materials such as polyurethane and cellulosic foams. A particularly preferred material is polyurethane due to the low cost, ready availability and the ease with which the material can be made into various shapes.

In the preferred process, a reticulated organic polymer foam is impregnated with aqueous slurry of ceramic precursor. Detailed procedures are described in U.S. Pat. Nos. 3,962,081; 4,075,303 and 4,024,212 which are incorporated herein by reference thereto. The flexible foam material is impregnated such that the ceramic slurry coats the fiber-like webs of the foam and substantially fills the voids therein. It is typically preferred to simply immerse the foam in the slurry for a short period of time sufficient to ensure that the foam is nearly completely impregnated. The impregnated foam can then be compressed to expel a portion of the slurry while leaving the fiber-like web portion coated therein with a plurality of pores throughout the body to increase the available path lengths for light transmission.

In an alternative embodiment a ceramic precursor comprising spherically shaped voids therein can be formed into the desired shape of the diffuser and fired as described in U.S. Pat. No. 6,773,825 which is incorporated herein by reference thereto.

A mixture of ceramic or metal particles and pliable organic spheres is prepared into a liquid, or suspension, and the mixture is formed into a shaped article. The shaped article is dried and fired so that the particles are bonded by sintering. The organic spheres and other organic additives are volatilized. The spheres are preferably low density and more preferably hollow. The size of the voids may be preselected by selecting the appropriate polymer spheres. The porosity is also easily controlled by the number of polymer spheres added. It is most preferred that the polymer spheres are each in contact with at least two other spheres such that a network of voids is created in the eventual diffuser.

Without being limited thereto, for a ceramic diffuser with an average pore sizes above about 130 μm the sponge replication process is most preferred. For a ceramic diffuser with an average pore sizes below about 130 μm the organic sphere process is most preferred

The porous ceramic assembly may comprise multiple porous ceramic diffusers as described previously. The porous ceramic diffusers may be formed and then joined in an assembly. This is referred to herein as utilizing distinct porous ceramic diffusers since the diffusers are not fused. Joining preformed porous ceramic diffusers can be done by gluing or by the use of standard attachment elements such as threaded members, rivets, bands, etc. or they may be in a frame member which secures the porous ceramic diffusers in a preferred orientation relative to one another. In another embodiment the porous ceramic diffusers can be manufactured by first attaching open cell foam elements together to form the desired configuration. This is preferably done by gluing the individual elements. The combined open cell foam elements are then saturated and fired as described previously. This is referred to herein as fusing the porous ceramic diffusers. In yet another embodiment the individual foam elements can be saturated with ceramic precursors. The saturated foam is then oriented together and fired. The contact regions will sinter therefore forming a continuous ceramic. In yet another embodiment the porous ceramic diffusers can be glued with ceramic precursor and then refired to fuse the elements together.

Ceramic precursors typically include a solvent, such as water, organic binders, and materials which, upon heating, form a ceramic. The ceramic precursor is preferably a ceramic slurry which is thixotropic, has a reasonable degree of fluidity and a rheology such that the slurry will tend to stay in place when work is not applied to it. This is typically referred to as a high yield strength.

Ceramic precursors typically include ceramic powders or slurries. Preferred materials include metals or metal alloys, such as copper, brass, stainless steel, alumina or FeCrAlY which is a known alloy of iron, chromium, aluminum and yttrium; silicon carbide, zirconium and cordierite bonded with phosphates; silica, fumed or colloidal; or glass frit such as calcium borosilicate glass.

The article is typically dried by suitable means, such as air drying, accelerated drying at a temperature of about 100° F. to 600° F. for about 15 minutes to 6 hours, microwave drying or the like. After drying the material is fired at elevated temperatures preferably in excess of about 2000° F. to sinter the ceramic and volatilize the organics. Heating to temperatures as high as 2500° F. can be used. Firing times at or near the peak temperature for at least 5 minutes is preferred and at least 10-15 minutes is more preferred. Heating temperature and time can vary depending on the type of furnace, ceramic used and other criteria such the incorporation of glazes and other adjuvants.

Glazes are well known in the art. Glazes typically include a metal oxide and binder which, when fired, imparts a color to the ceramic. Typical oxides include, titanium, iron, aluminum, tin, cerium, cobalt, copper, chromium and manganese. Pearlescent pigments, for example, comprise mica with oxides of various metals coated thereon. A particularly preferred glaze is a clear glaze of calcium borosilicate glass which can be added into the ceramic precursor.

The porous nature of the ceramic allows materials to pass through. It is contemplated herein that various materials may be incorporated into the pores for specific aesthetic effects such as flowing, or stationary, liquids, gases, smoke, and the like.

The invention has been described with particular reference to the preferred embodiments. Other embodiments and alterations could be realized based on the teachings herein without departing from the scope of the invention which is set forth in the claims appended hereto.

1. A lamp comprising an illuminator and a porous ceramic diffuser.

2. The lamp of claim 1 wherein said porous ceramic diffuser has an average pore size of at least 15 μm to no more than 7000 μm.

3. The lamp of claim 2 wherein said porous ceramic diffuser has an average pore size of at least 500 μm to no more than 7000 μm.

4. The lamp of claim 1 comprising a porous ceramic light diffuser assembly with multiple porous ceramic diffusers in said porous light diffuser assembly.

5. The lamp of claim 4 wherein at least two of said multiple porous ceramic diffusers are in contact.

6. The lamp of claim 4 wherein at least two of said multiple porous ceramic diffusers are fused.

7. The lamp of claim 4 wherein at least two of said multiple porous ceramic diffusers are distinct.

8. The lamp of claim 1 further comprising a base.

9. The lamp of claim 8 wherein said illuminator and said porous ceramic diffuser are attached to said base.

10. The lamp of claim 1 wherein said porous ceramic diffuser comprises a cavity and said illuminator is in said cavity.

11. The lamp of claim 10 wherein said porous ceramic diffuser is a globe.

12. The lamp of claim 1 wherein said porous ceramic diffuser comprises a glaze.

13. The lamp of claim 12 wherein said glaze is borosilicate glass.

14. A light comprising:
a base;
a porous ceramic diffuser attached to said base wherein said porous ceramic diffuser comprises a cavity; and
an illuminator attached to said base and in said cavity.

15. The light of claim 14 wherein said base is a plate.

16. The light of claim 14 wherein said porous ceramic diffuser has an average pore size of at least 15 μm to no more than 7000 μm.

17. The light of claim 16 wherein said porous ceramic diffuser has an average pore size of at least 500 μm to no more than 7000 μm.

18. The light of claim 14 further comprising a porous ceramic diffuser assembly.

19. The light of claim 18 wherein said porous ceramic diffuser assembly comprises multiple porous ceramic diffusers.

20. The light of claim 19 wherein said multiple porous ceramic diffusers are fused.

21. The light of claim 19 wherein said multiple porous ceramic diffusers are distinct.

22. The light of claim 14 wherein said porous ceramic diffuser is a globe.

23. The light of claim 14 wherein said porous ceramic diffuser comprises a glaze.

24. The light of claim 23 wherein said glaze is borosilicate glass.

25. A light comprising:
a porous ceramic diffuser assembly comprising at least one porous ceramic diffuser with an average pore size of at least 15 μm to no more than 7000 μm and a cavity; and
an illuminator in said cavity.

26. The light of claim 25 wherein said average pore size is at least 500 μm to no more than 7000 μm.

27. The light of claim 25 wherein said porous ceramic diffuser assembly is a g lobe.

28. The light of claim 25 wherein said porous ceramic diffuser assembly comprises multiple porous ceramic diffusers.

29. The light of claim 28 wherein at least one porous ceramic diffuser of said multiple porous ceramic diffusers is planar.

30. The light of claim 28 wherein at least two of said multiple porous ceramic diffusers are fused.

31. The light of claim 28 wherein said multiple porous ceramic diffusers are distinct.

32. The light of claim 25 wherein said porous ceramic diffuser comprises a glaze.

33. The light of claim 32 wherein said glaze is borosilicate glass.
